(19) United States
(12) Patent Application Publication
(10) Pub. No.: US 2020/0094694 A1
(43) Pub. Date: Mar. 26, 2020

(54) MOTOR DRIVE AND FLIGHT CONTROL METHOD, ELECTRONIC SPEED CONTROL, POWER SYSTEM, AND UNMANNED AERIAL VEHICLE SYSTEM

(71) Applicant: SZ DJI TECHNOLOGY CO., LTD., Shenzhen (CN)

(72) Inventor: Liang ZHANG, Shenzhen (CN)

(21) Appl. No.: 16/698,289

(22) Filed: Nov. 27, 2019

Related U.S. Application Data
(63) Continuation of application No. PCT/CN2017/094886, filed on Jul. 28, 2017.

(51) Int. Cl. B60L 15/20; B64C 39/02; H02P 6/08; H02P 6/30

(52) U.S. Cl. CPC B60L 15/20; B64C 39/024; H02P 6/08; B64D 47/08; B64C 2201/027; B64C 2201/042; B64C 2201/146; H02P 6/30

(57) ABSTRACT

An electric motor driving method includes receiving a throttle signal sent by a flight controller, and controlling an electric motor to rotate according to the throttle signal. The throttle signal includes a differential signal.

### CROSS-REFERENCE TO RELATED APPLICATION

This application is a continuation of International Application No. PCT/CN2017/094886, filed on Jul. 28, 2017, the entire content of which is incorporated herein by reference.

### TECHNICAL FIELD

The present disclosure relates to the field of control technology and, more particularly, to an electric motor driving method, a flight control method, an electronic speed control, a power system, and an unmanned aerial vehicle (UAV) system.

### BACKGROUND

In the UAV, a flight controller sends a single-ended throttle signal to the electronic speed control (ESC). Based on the received throttle signal, the ESC controls rotation of a corresponding electric motor, thereby supplying flight power to the UAV.

Generally, a frame of the UAV includes a center body and an arm attached to the center body. The flight controller is often disposed on the center body. The ESC and the electric motor are often disposed at an end of the arm away from the center body. The single-ended throttle signal sent by the flight controller needs to go through a long transmission path to reach the ESC. In the meantime, the single-ended throttle signal is subject to signal interference, electromagnetic interference, and timing signal jitter. As a result, the throttle signal received by the ESC may inaccurate and may be unable to accurately control the rotation of the corresponding electric motor, thereby unable to precisely control flying of the UAV.

### SUMMARY

In accordance with the disclosure, there is provided an electric motor driving method includes receiving a throttle signal sent by a flight controller, and controlling an electric motor to rotate according to the throttle signal. The throttle signal includes a differential signal

An unmanned aerial vehicle (UAV) system includes a frame, a power system disposed at the frame, and a flight controller. The power system includes an electric motor and an electronic speed control (ESC) communicatively coupled with the electric motor and configured to control operation of the electric motor. The flight controller is communicatively coupled with the ESC and configured to send a throttle signal to the ESC. The throttle signal includes a differential signal. The ESC is further configured to control the electric motor to rotate according to the throttle signal.

### BRIEF DESCRIPTION OF THE DRAWINGS

To more clearly illustrate the technical solution in the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be encompassed in the present disclosure.

FIG. 1 is a structural block diagram of an unmanned aerial vehicle (UAV) system according to an example embodiment of the present disclosure.

FIG. 2 is a flowchart of an electric motor driving method according to an example embodiment of the present disclosure.

FIG. 3 is a flowchart of an electric motor driving method according to another example embodiment of the present disclosure.

FIG. 4 is a flowchart of a flight control method according to an example embodiment of the present disclosure.

FIG. 5 is a structural block diagram of an electronic speed control according to an example embodiment of the present disclosure.

FIG. 6 is a structural block diagram of a flight control system according to an example embodiment of the present disclosure.

FIG. 7 is a three-dimensional perspective view of an unmanned aerial vehicle according to an example embodiment of the present disclosure.

The numerals and labels in the drawings are summarized below.

100 Electronic Speed Control (ESC)

101 First processor

200 Flight controller

201 Second processor

300 Electric motor

1 Frame

11 Center body

12 Arm

2 Power system

3 Gimbal

4 Photographing device

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

An electric motor driving method, a flight control method, an electronic speed control, a power system, and an unmanned aerial vehicle (UAV) system are described in detail below with reference to the drawings. The features described in the embodiments of the present disclosure may be combined with each other under a no-conflict condition.

FIG. 1 is a structural block diagram of an unmanned aerial vehicle (UAV) system according to an example embodiment of the present disclosure. As shown in FIG. 1, the UAV system includes a flight controller 200 and a power system 2. The power system 2 includes an electronic speed control (ESC) 100 and an electric motor 300 (or simply referred to as “motor”). The flight controller 200 is communicatively coupled with the ESC 100, and the ESC 100 is communicatively coupled with the electric motor 300. The controller 200 is communicatively coupled with the ESC 100 by differential signal lines, such that a loss of a throttle signal transmitted from the flight controller 200 to the ESC 100 is reduced, and a precise control of the electric motor 300 is achieved.

The type of the electric motor 300 may be selected according to actual needs. For example, the electric motor 300 may be a brushless electric motor or a brushed electric motor, or a single-phase or three-phase or four-phase electric motor, which is not limited by the present disclosure.

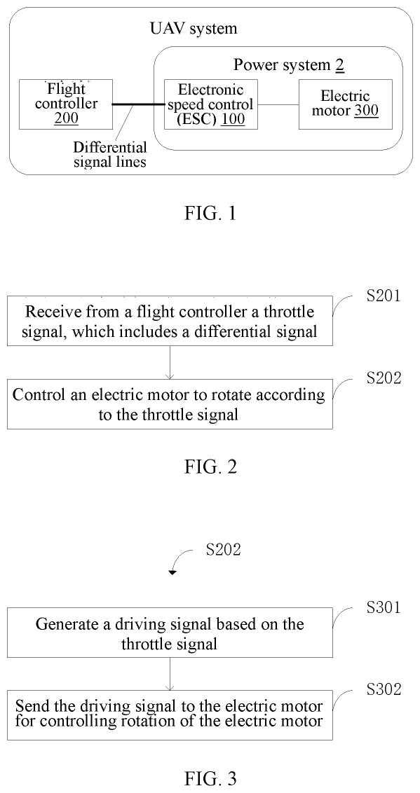

The present disclosure provides an electric motor driving method. The electric motor driving method may be applied to the ESC. The method is described in detail below with reference to FIGS. 2 and 3.

FIG. 2 is a flowchart of an electric motor driving method according to an example embodiment of the present disclosure. Referring to FIG. 2, the electric motor driving method includes the following.

At S201, a throttle signal sent by a flight controller is received. The throttle signal includes a differential signal.

The throttle signal includes operation parameters required for driving the electric motor 300, such as an electric motor rotation speed and an electric motor rotation direction. In some embodiments, the differential throttle signal includes two voltage signals with equal amplitudes but opposite polarities. The ESC 100 receives the two voltage signals with the equal amplitudes but opposite polarities at the same time and controls the corresponding electric motor 300 (i.e., the electric motor 300 coupled with the ESC 100) to rotate according to the two received voltage signals.

At S202, the electric motor is controlled to rotate according to the throttle signal.

After the throttle signal is received at S201, the ESC 100 immediately performs the process at S202 to timely drive the electric motor 300 to rotate.

In some embodiments, the flight controller 200 sends the differential throttle signal to the ESC 100 to drive the electric motor 300 to rotate. Because the differential throttle signal is resistant to signal interference, effectively suppresses electromagnetic interference, and provides accurate timing clock, the ESC 100 obtains the accurate throttle signal to accurately control the electric motor 300, thereby achieving a precise control of the UAV.

FIG. 3 is a flowchart of an electric motor driving method according to another example embodiment of the present disclosure. As shown in FIG. 3, controlling the electric motor to rotate (S202) includes the following.

At S301, a driving signal is generated based on the throttle signal.

In some embodiments, the driving signal includes at least one of an electric motor rotation speed control signal or an electric motor rotation direction control signal for controlling the electric motor 300 to rotate at a particular speed clockwise or counterclockwise, thereby satisfying the need for a particular driving power. In some other embodiments, the driving signal may further include other parameter signals for the operation of the electric motor, such as an operating current, an operating temperature, and a vibration magnitude, etc.

In some embodiments, the driving signal may be a driving voltage signal for controlling the operation of the electric motor 300 to supply driving power to the UAV. In some other embodiments, the driving signal may be a driving current signal or a driving power signal.

In some embodiments, generating the driving signal (S301) may include: calculating a voltage difference between the two voltage signals of the currently received throttle signal, and generating the driving signal based the voltage difference. The ESC 100 calculates the voltage difference between the two voltage signals of the currently received throttle signal to obtain the accurate throttle signal. Further, the accurate driving signal is generated to achieve the precise control of the electric motor 300.

At S302, the driving signal is sent to the electric motor for controlling rotation of the electric motor.

In some embodiments, the electric motor driving method is applied to the UAV. The ESC 100 drives the corresponding electric motor 300 to rotate, which in turn drives a corresponding propeller to rotate, thereby supplying flying power to the UAV. The electric motor driving method provided by the embodiments of the present disclosure may be applied to other movable platforms, such as a movable vehicle (e.g., a robot, a remotely-controlled car, etc.)

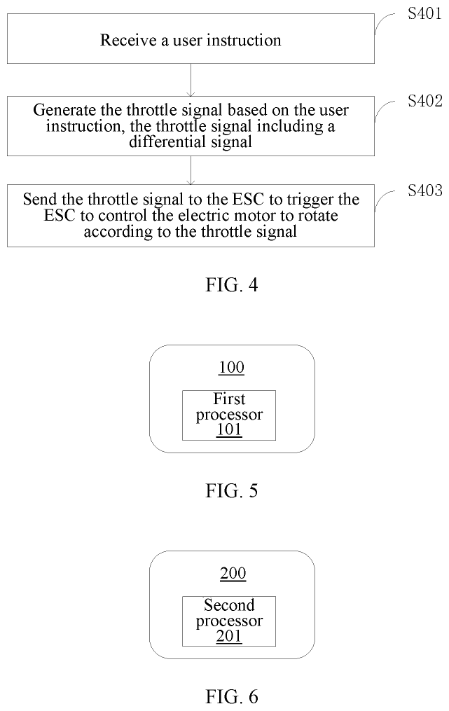

The present disclosure also provides a flight control method. FIG. 4 is a flowchart of a flight control method according to an example embodiment of the present disclosure. The flight control method may be applied to the flight controller 200 of the UAV for controlling the flight of the UAV. The method is described in detail below with reference to FIG. 4.

Referring to FIG. 4, the flight control method includes the following.

At S401, a user instruction is received.

In some embodiments, to flexibly control the UAV, the flight controller 200 communicates with a remote-control device of the UAV. The remote-control device sends the user instruction. The remote-control device may be a UAV remote controller or a device installed with application software (APP).

In some embodiments, the user instruction includes at least one of an electric motor rotation speed or an electric motor rotation direction for controlling the electric motor 300 to rotate at a particular speed clockwise or counterclockwise, thereby satisfying the need for a particular driving power. In some other embodiments, the user instruction may further include other parameter signals for the operation of the electric motor, such as an operating current, an operating temperature, and a vibration magnitude, etc.

At S402, a throttle signal is generated based on the user instruction. The throttle signal includes a differential signal.

After the user instruction is received at S401, the flight controller 200 performs the process at S402 to ensure a timely control of the electric motor 300.

In some embodiments, generating the throttle signal (S402) may include generating two voltage signals with equal amplitudes but opposite polarities as the differential throttle signal. When being transmitted from the flight controller 200 to the ESC 100, the differential throttle signal is resistant to signal interference, causes minimal electromagnetic interference to the ambient environment (i.e., effectively suppresses electromagnetic interference), and provides accurate timing clock. As such, the ESC 100 obtains the accurate throttle signal to generate an accurate driving signal to accurately control the electric motor 300 to rotate.

At S403, the throttle signal is sent to the ESC to trigger the ESC to control the electric motor to rotate according to the throttle signal.

In some embodiments, sending the throttle signal to the ESC (S403) may include synchronously transmitting the two voltage signals to the ESC 100 along the differential signal lines to further ensure that the ESC 100 obtains the accurate throttle signal. For example, the differential signal lines include two adjacently disposed signal lines separately transmitting two voltage signals with the equal amplitudes but opposite polarities. The two signal lines are subject to noises with equal amplitudes, such that the noises cancel out with each other and hence do not affect the throttle signal. At the same time, electromagnetic fields coupled between the two signal lines and the ground have equal amplitudes but opposite polarities, such that the electromagnetic fields cancel out with each other and the electromagnetic interference is substantially reduced. In addition, the ESC 100 takes the difference between the voltage signals transmitted through the two adjacent signal lines as transition points of signal logic 0/1. Compared with scenarios using single-ended throttle signal where threshold voltages are considered as transition points of signal logic 0/1 (the single-ended throttle signal is more likely to be affected by a ratio of the threshold voltages to the signal amplitude voltages, and is not suitable for low amplitude throttle signal), the differential signal lines support higher sensitivity and are more suitable for the low amplitude throttle signal.

In some embodiments, the flight controller 200 sends the differential throttle signal to the ESC 100 to drive the electric motor 300 to rotate. Because the differential throttle signal is resistant to signal interference, effectively suppresses electromagnetic interference, and provides accurate timing clock, the ESC 100 obtains the accurate throttle signal to accurately control the electric motor 300, thereby achieving the precise control of the UAV.

FIG. 5 schematically shows an electric motor driving system according to an example embodiment of the present disclosure. As shown in FIG. 5, the electric motor driving system includes a first processor 101. The first processor 101 is communicatively coupled with the corresponding electric motor 300 for controlling the operation of the electric motor 300 or receiving information fed back from the corresponding electric motor 300.

In some embodiments, the electric motor driving system can include one or more first processors 101 that operate individually or collectively to perform an electric motor driving method consistent with the present disclosure, such as one of the above-described example methods.

FIG. 6 is a structural block diagram of a flight control system according to an example embodiment of the present disclosure. As shown in FIG. 6, the flight control system (i.e., the flight controller) 200 includes a second processor 201. The second processor 201 is communicatively coupled with the ESC 100 of the UAV.

In some embodiments, the flight controller 200 can include one or more second processors 201 that operate individually or collectively to perform a flight control method consistent with the present disclosure, such as one of the above-described example methods.

The present disclosure also provides a computer storage medium. The computer storage medium stores program instructions. When being executed, the program instructions cause a processor (such as the first processor 101) to perform an electric motor driving method consistent with the disclosure, or cause a processor (such as the second processor 201) to perform a flight control method consistent with the disclosure.

Referring to FIG. 5 again, the present disclosure also provides an ESC 100. The ESC 100 includes a housing and a control system mounted inside the housing. The control system includes one or more first processors 101, which operate individually or collectively. The first processor 101 is communicatively coupled with the corresponding electric motor 300 for controlling the operation of the electric motor 300 or receiving information fed back from the corresponding electric motor 300.

In some embodiments, the one or more first processors 101 are configured to perform an electric motor driving method provided by the embodiments of the present disclosure, such as one of the above-described example methods.

Referring to FIG. 1, the present disclosure also provides a power system 2. The power system 2 includes an ESC 100 and an electric motor 300. The ESC 100 is communicatively coupled with the electric motor 300 for controlling the operation of the electric motor 300. The ESC 100 includes a housing and a control system mounted inside the housing.

The control system includes one or more first processors 101, which operate individually or collectively. The one or more first processor 101 are communicatively coupled with the electric motor 300 for controlling the operation of the electric motor 300 or receiving information fed back from the corresponding electric motor 300.

In some embodiments, the one or more first processors 101 are configured to perform an electric motor driving method provided by the embodiments of the present disclosure, such as one of the above-described example methods.

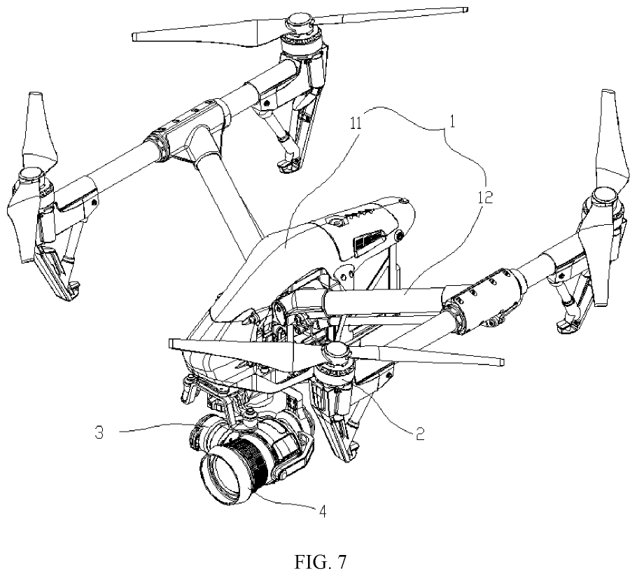

Referring to FIG. 1 and FIG. 7, the present disclosure also provides a UAV system. The UAV system includes a UAV, a gimbal 3 mounted at the UAV, and a photographing device 4 mounted at the gimbal 3. The UAV includes a frame 1, a power system 2, and a flight controller 200.

In some embodiments, as shown in FIG. 7, the UAV system includes a plurality of power systems 2 disposed at the frame 1. Referring to FIG. 1, the power system 2 includes the ESC 100 and the electric motor 300. The ESC 100 is communicatively coupled with the electric motor 300 for controlling the operation of the electric motor 300.

The flight controller 200 is communicatively coupled with the ESC 100. Referring to FIG. 1, the flight controller 200 is communicatively coupled with the ESC 100 by the differential signal lines. The differential signal lines are disposed inside the arm 12.

In some embodiments, the flight controller 200 sends the throttle signal to the ESC 100. The ESC 100 controls the corresponding electric motor 300 to rotate according to the throttle signal to supply the flight power to the UAV. The throttle signal includes the differential signal.

In some embodiments, the flight controller 200 sends the differential throttle signal to the ESC 100 to drive the electric motor 300 to rotate. Because the differential throttle signal is resistant to signal interference, effectively suppresses electromagnetic interference, and provides accurate timing clock, the differential throttle signal can be accurately received by the ESC 100 even after transmitting through a long transmission path. Thus, the ESC 100 can accurately control the electric motor 300, thereby achieving a precise control of the UAV.

Referring to FIG. 7, the frame 1 includes a center body 11 and an arm 12. The flight controller 200 is mounted inside the center body 11. One end of the arm 12 is connected to the center body 11 and the other end is connected to the ESC 100. The arm 12 and the center body 11 may be assembled together by snapping, fasteners, or other interlocking mechanism. The housing of the ESC 100 may be fastened to one end of the arm 12 by snapping, fasteners, or other interlocking mechanism.

The UAV also includes a power supply connected to the ESC 100 through power supply lines disposed inside the arm 12. The transmission of the conventional single-ended signal line is subject to interference from the power supply lines. Changing the single-ended signal line to the differential signal lines reduces the interference from the power supply lines to the throttle signal.

In some embodiments, the flight controller 200 receives the user instruction and generates the throttle signal based on the user instruction. To flexibly control the UAV, the flight controller 200 is communicatively coupled with the remote-control device of the UAV. The user instruction is sent by the remote-control device. The remote-control device may be a UAV remote controller or a device installed with application software (APP).

In some embodiments, the user instruction includes at least one of an electric motor rotation speed or an electric motor rotation direction for controlling the electric motor 300 to rotate at a particular speed clockwise or counterclockwise, thereby satisfying the need for a particular driving power. In some other embodiments, the user instruction may further include other parameter signals for the operation of the electric motor, such as an operating current, an operating temperature, and a vibration magnitude, etc.

The flight controller 200 generates two voltage signals with equal amplitudes but opposite polarities based on the electric motor rotation speed and the electric motor rotation direction. When being transmitted from the flight controller 200 to the ESC 100, the differential throttle signal is resistant to signal interference, causes minimal electromagnetic interference to the ambient environment (i.e., effectively suppresses electromagnetic interference), and provides accurate timing clock. As such, the ESC 100 obtains the accurate throttle signal to generate an accurate driving signal to accurately control the electric motor 300 to rotate.

The flight controller 200 synchronously transmits the two voltage signals to the ESC 100 along the differential signal lines to further ensure that the ESC 100 obtains the accurate throttle signal. For example, the differential signal lines include two adjacently disposed signal lines separately transmitting two voltage signals with the equal amplitudes but opposite polarities. The two signal lines are subject to noises with equal amplitudes, such that the noises cancel out with each other and hence do not affect the throttle signal. At the same time, electromagnetic fields coupled between the two signal lines and the ground have equal amplitudes but opposite polarities, such that the electromagnetic fields cancel out with each other and the electromagnetic interference is substantially reduced. In addition, the ESC 100 takes the difference between the voltage signals transmitted through the two adjacent signal lines as transition points of signal logic 0/1. Compared with scenarios using single-ended throttle signal where threshold voltages are considered as transition points of signal logic 0/1 (the single-ended throttle signal is more likely to be affected by a ratio of the threshold voltages to the signal amplitude voltages, and is not suitable for low amplitude throttle signal), the differential signal lines support higher sensitivity and are more suitable for the low amplitude throttle signal.

The ESC 100 generates the driving signal based on the throttle signal and sends the driving signal to the electric motor 300 for controlling the rotation of the electric motor 300. For example, the ESC 100 calculates the voltage difference between the two voltage signals of the currently received throttle signal and generates the driving signal based on the voltage difference. In some embodiments, the ESC 100 calculates the voltage difference between the two simultaneously received voltage signals of the throttle signal to obtain the accurate throttle signal and to further generate the accurate driving signal, thereby achieving the precise control of the electric motor 300.

In some embodiments, the driving signal includes at least one of the electric motor rotation speed control signal or the electric motor rotation direction control signal for controlling the electric motor 300 to rotate at a particular speed clockwise or counterclockwise, thereby satisfying the need for a particular driving power. In some other embodiments, the driving signal may further include other parameter signals for the operation of the electric motor, such as the operating current, the operating temperature, and the vibration magnitude, etc.

In some embodiments, the driving signal may be a driving voltage signal for controlling the operation of the electric motor 300 to supply driving power to the UAV. In some other embodiments, the driving signal may be a driving current signal or a driving power signal.

The embodiments of the present are presented in a progressive manner. The differences between different embodiments are described and the common features are omitted and referred to the previous description.

For the device embodiments, the operation principles are corresponding to the method embodiments. For description of related parts of the device embodiments, reference may be made to the description of the related parts of the method embodiments. The description of the device embodiments is intended to be illustrative. The units described as separate parts may or may not be physically separated. The parts displayed as units may or may not be physical units, that is, may not be located in one place, and may be distributed in a plurality of network units. Some or all modules may be selected according to actual needs to achieve the objectives of the technical solution of the present disclosure. Those of ordinary skill in the art may comprehend and implement the technical solution without any creative effort.

The description of the “examples” or “some embodiments” is intended to include the particular features, structures, materials, or characteristics described included in at least one example or one embodiment. In the specification, the representation of the above terms does not necessarily mean the same example or same embodiment. Further, the described features, structures, materials, or characteristics may be combined in a suitable manner in one or more examples or embodiments.

Any process or method described in the flowcharts or in other manners may be understood as a module, a fragment, or a portion of code that includes one or more executable instructions for implementing a particular logic function or a particular process. The scope of the embodiments of the present disclosure includes additional implementations. The embodiments may not be implemented according to the order of the illustrations or discussions. Some or all functions may be implemented concurrently or in a reverse order, which should be understood by those of ordinary skill in the art.

The logic and/or step described in the flowcharts or in other manners may be considered as, for example, an ordered list of executable instructions for implementing the logic functions and may be embodied in any computer-readable storage medium for use by an instruction execution system, an apparatus, a device (e.g., a computer-based system, a system including a processor, or other instruction execution system where an apparatus or a device retrieves and executes the instructions), or combinations thereof. In the specification, “computer-readable storage medium” may be any medium that contains, stores, communicates, propagates, or transfers programs for use in the instruction execution system, the apparatus, the device, or combinations thereof. For example, the computer-readable storage medium may include, but is not limited to, an electrical connection including one or more wires (an electronic device), a portable computer disk cartridge (a magnetic device), a random-access memory (RAM), a read-only memory (ROM), an erasable programmable read-only memory (EPROM or flash memory), an optical fiber device, and a portable optical disk read-only memory (CD-ROM). In addition, the computer-readable storage medium may be papers printed with the programs or other suitable medium because the papers or other medium may be optically scanned, edited, interpreted, or processed in other suitable manners to electronically obtain the programs, which can then be stored in the computer-readable storage medium.

Some or all portions of the embodiments may be implemented in hardware, software, firmware, or combinations thereof. In some embodiments, the processes or methods may be implemented in software or firmware stored in the memory and executed by a suitable instruction execution system. In some other embodiments, the processes or methods may be implemented in hardware including any one of the following well-known technical solutions or combinations thereof, such as discrete logic circuits including logic gate circuits for implementing logic functions on digital data signals, application specific integrated circuits including suitable combination logic gate circuits, programmable gate arrays (PGA), and field programmable gate arrays (FPGA).

Those of ordinary skill in the art can understand that all or some of the processes implementing the foregoing embodiments of the present disclosure may be implemented by programs instructing the related hardware the programs may be stored in the computer-readable storage medium. When being executed, the programs performs the processes implementing all or some method embodiments.

In addition, the functional units in the embodiments of the present disclosure may be integrated into one processing module, may be distributed to a plurality of physically separate units, or may have two or more units integrated into one module. The integrated modules may be implemented in hardware or in software function modules. When being implemented in software function modules and used or sold as an independent product, the integrated modules may be stored in the computer-readable storage medium.

The storage medium may be a read-only memory (ROM), a magnetic disk, or an optical disk. The foregoing descriptions are merely some implementation manners of the present disclosure, but the scope of the present disclosure is not limited thereto. Without departing from the spirit and principles of the present disclosure, any modifications, equivalent substitutions, and improvements, etc., shall fall within the scope of the present disclosure. The scope of the invention should be determined by the appended claims.

What is claimed is:

1. An electric motor driving method comprising:
receiving a throttle signal sent by a flight controller, the throttle signal including a differential signal; and
controlling an electric motor to rotate according to the throttle signal.

2. The method of claim 1, wherein controlling the electric motor to rotate according to the throttle signal includes:
generating a driving signal based on the throttle signal; and
sending the driving signal to the electric motor to control the electric motor to rotate.

3. The method of claim 2, wherein generating the driving signal based on the throttle signal includes:
calculating a voltage difference between two voltage signals of the throttle signal; and
generating the driving signal based on the voltage difference.

4. The method of claim 2, wherein the driving signal includes at least one of an electric motor rotation speed control signal or an electric motor rotation direction control signal.

5. The method of claim 2, wherein the driving signal includes a driving voltage signal.

6. An unmanned aerial vehicle (UAV) system comprising:
a frame;
a power system disposed at the frame, the power system including:
an electric motor; and
an electronic speed control (ESC) communicatively coupled with the electric motor and configured to control operation of the electric motor; and
a flight controller communicatively coupled with the ESC and configured to send a throttle signal to the ESC, the throttle signal including a differential signal;
wherein the ESC is further configured to control the electric motor to rotate according to the throttle signal.

7. The system of claim 6, wherein the ESC is further configured to generate a driving signal based on the throttle signal and send the driving signal to the electric motor to control the electric motor to rotate.

8. The system of claim 7, wherein the ESC is further configured to calculate a voltage difference between two voltage signals of the throttle signal and generate the driving signal based on the voltage difference.

9. The system of claim 7, wherein the driving signal includes at least one of an electric motor rotation speed control signal or an electric motor rotation direction control signal.

10. The system of claim 7, wherein the driving signal includes a driving voltage signal.

11. The system of claim 6, wherein the flight controller is further configured to receive a user instruction and generate the throttle signal based on the user instruction.

12. The system of claim 11, wherein the user instruction includes at least one of an electric motor rotation speed or an electric motor rotation direction.

13. The system of claim 12, wherein the flight controller is further configured to generate two voltage signals with equal amplitudes but opposite polarities based on the electric motor rotation speed or the electric motor rotation direction.

14. The system of claim 13, wherein the flight controller is further configured to synchronously transmit the two voltage signals to the ESC along differential signal lines.

15. The system of claim 6, wherein:
the frame includes a center body and an arm;
the flight controller is mounted inside the center body;
one end of the arm is coupled with the center body; and
another end of the arm is coupled with the ESC.

16. The system of claim 15, wherein the flight controller is coupled with the ESC by differential signal lines disposed inside the arm.

17. The system of claim 16, further comprising:
a power supply coupled with the ESC through a power supply line disposed inside the arm.
